(19) United States
(12) Patent Application Publication
(10) Pub. No.: US 2017/0245967 A1
(43) Pub. Date: Aug. 31, 2017

(54) Dental Retraction Cord Band(s)

(71) Applicant: Linda Edwards, Denton, TX (US)

(72) Inventor: Linda Edwards, Denton, TX (US)

(21) Appl. No.: 15/056,218

(22) Filed: Feb. 29, 2016

(51) Int. Cl. A61C 9/00

(52) U.S. Cl. CPC A61C 9/0033

(57) ABSTRACT

A dental retraction cord band is used to create a gap between a tooth under repair and the surrounding gingival tissue. The gap between the tooth and the gingival tissue is necessary to make an accurate impression for subsequent construction of a crown or bridge. The dental retraction cord band is constructed from an elastic material such as cotton, fits snugly around the tooth and is pressed into the space between the tooth and gingival tissue. When the dental retraction cord band is removed, a gap is created between the tooth and gingival tissue for placement of the mold device and construction of an accurate impression of the tooth. The dental retraction cord band may be constructed of various sizes to fit around various sizes of teeth. The dental retraction cord band may also be constructed in different widths to make a larger or small gap as desired.

### CROSS-REFERENCE TO RELATED APPLICATIONS

Not applicable

### STATEMENT REGARDING FEDERALLY SPONSORED RESEARCH OR DEVELOPMENT

No part of the invention disclosed herein was the subject of federally sponsored research or development.

### THE NAMES OF THE PARTIES TO A JOINT RESEARCH AGREEMENT

Not applicable

### REFERENCE TO A SEQUENCE LISTING

Not applicable

### BACKGROUND

Field

The field of the invention disclosed here is dental care and specifically the preparation of teeth for making impressions for the construction of dental crowns and bridges.

Description of the Prior Art

Many dental procedures require creating a mold of the affected tooth in order to create a replacement or crown. In order to accurately make the replacement or crown the mold must fit snugly around the tooth. In some circumstances this is completed by creating a gap between the tooth and gingival tissue. The mold apparatus is then fitted over the tooth and into the gap between the tooth and gingival tissue. As shown in FIGS. 1 and 1a, prior art methods have used retraction cords which are wrapped around the base of the tooth and forced into position between the tooth and gingival tissue and create the gap between the tooth and the gingival tissue for insertion of the mold apparatus (FIG. 2). This prior art method is time-consuming, tedious, prone to failure and painful for the patient. What is needed in the art is an easy, convenient and relatively painless retraction cord to create the gap between a tooth and the gingival surface for molding an impression of the tooth.

### BRIEF DESCRIPTION OF THE INVENTION

The invention disclosed herein is an easy, convenient and relatively painless retraction device to create the gap between a tooth and the gingival surface for molding an impression of the tooth. Specifically, the invention disclosed herein is retraction cord band which is circular in orientation and constructed of an elastic cloth material which can be placed around the tooth in order to create the gap between the tooth and gingival tissue for impression molding.

### BRIEF DESCRIPTION OF THE DRAWING/FIGURES

A better understanding of the invention disclosed herein may be had by examination of the following drawing/figures:

FIG. 1 is a side view of the prior art device used to create a gap between the tooth and the gingival tissue.

FIG. 1A is a side view of the prior art device used to create a gap between the tooth and the gingival tissue.

FIG. 2 is a side view showing the gap between the tooth and gingival surface after removal of the retraction cord

FIG. 3 is a side view of the retraction cord band inserted between the tooth and gingival tissue to create a gap.

FIG. 4. is a side view showing the gap created by the removal of the retraction cord band between the tooth and gingival tissue.

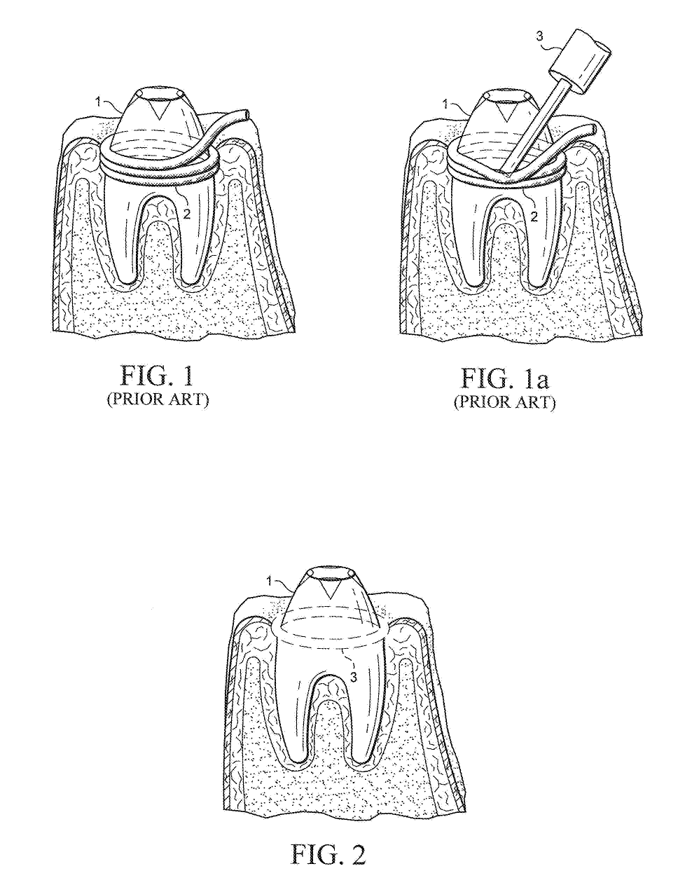

### DETAILED DESCRIPTION OF THE INVENTION

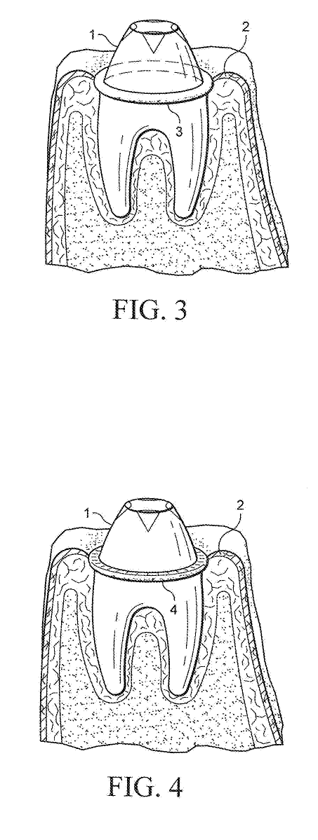

The invention disclosed herein is an improvement over prior art methods for dental care in which a gap is formed between a tooth and the gingival tissue for accurate placement of the mold device for correct construction of an impression of the tooth. Specifically, the invention disclosed herein is a retraction cord band which is placed around the tooth and between the tooth and gingival tissue to create a gap for accurate impression molding. As shown in FIG. 3 the retraction cord band 3 is positioned around the tooth 1 and in between the tooth 1 and the gingival tissue 2. As shown in FIG. 4, when the retraction cord band 3 is removed from around the tooth 1 a gap 4 is formed between the tooth 1 and the gingival tissue 2. The molding device can then be placed over the tooth 1 and into the gap 4 between the tooth 1 and the gingival tissue 2 to enable an accurate impression of the tooth 1 to be made.

In one embodiment, the retraction cord band may be made from cotton fiber which is elastic and absorbent. In other embodiments the retraction cord band may be constructed of other elastic and absorbent materials. The retraction cord band may be made of various lengths and widths to fit over teeth of various sizes and to make the gap between the tooth and the gingival tissue wider if necessary. The retraction cord band may also be impregnated with various medications as needed. Those medications may include anesthetics, astringents, antibiotics or anti-inflammatory.

I claim:

1. A dental retraction cord band for use in making accurate impressions of a tooth under repair comprising:
a ring of elastic absorbent material.

2. The dental retraction cord band set forth in claim 1 wherein said elastic absorbent material is cloth.

3. The dental retraction cord band set forth in claim 1 wherein said elastic absorbent material is impregnated with an anesthetic.

4. The dental retraction cord band set forth in claim 1 wherein said elastic absorbent material is impregnated with an anti-inflammatory.

5. The dental retraction cord band set forth in claim 1 wherein said elastic absorbent material is impregnated with an antibiotic.

6. The dental retraction cord band set forth in claim 1 wherein said elastic absorbent material is impregnated with an astringent.
